(19) United States
(12) Patent Application Publication
(10) Pub. No.: US 2003/0038927 A1
(43) Pub. Date: Feb. 27, 2003

(54) IMAGE PROJECTOR WITH INTEGRATED IMAGE STABILIZATION FOR HANDHELD DEVICES AND PORTABLE HARDWARE

(76) Inventor: Ray M. Alden, Raleigh, NC (US)

Correspondence Address: Ray M. Alden, 808 Lake Brandon Trail, Raleigh, NC, 27610, US

(21) Appl. No.: 09/939,975

(22) Filed: Aug. 27, 2001

(51) Int. Cl. G03B 21/00

(52) U.S. Cl. 353/122

(57) ABSTRACT

The invention described herein represents a significant improvement for the presentation of visual information when using handheld devices. In on embodiment, a handheld device such as a cell phone is modified to include a means for projecting an image onto a remote surface such as a remote surface (wall). Also integrated are a means to sense when the cell phone moves relative to the image on the remote surface (wall) and to offset said relative movement through a means for stabilizing the image. This invention thus enables the user of the cell phone to produce and interact with a large visual media display while the size of the cell phone is not significantly increased. Many handheld devices will be improved by incorporating the means to project a large stable image disclosed herein.

### BACKGROUND FIELD OF INVENTION

Modern handheld electronic devices come in many shapes and sizes and perform many functions. The main advantage of a handheld device is its portability, a user can bring it anywhere and use it anytime. Increasingly the functionalities of devices such as phones, personal computers, PDAs, pagers, cameras, video games, audio players, video players, and even print media tablets are converging. Many observers believe that all of these devices will merge into one handheld device. Whereas the “wired” individual of today generally has several handheld devices in tow, soon the devices may all be replaced by one handheld do it all gadget. There still remains one aspect of all handheld devices which constrains their functionality, namely screen size.

Due to the portability necessity of handheld devices, screen size is a constraining issue on all known handheld devices. Small screens are highly portable but not practical for most uses, and large screens are highly cumbersome. What is needed is a solution that can significantly expand the screen size of handheld devices without making the devices any larger. The present application discloses a novel solution to multiplying the viewing screen size of handheld devices tens of times yet not increasing the overall size of the handheld device at all.

The present invention provides a significant step forward for handheld devices by integrating into them state of the art projection technology and state of the art image stabilization techniques. The results are a small handheld device with a large display projected onto nearly any flat surface. This enables a large visual presentation from a very small handheld device.

### BACKGROUND-DESCRIPTION OF PRIOR INVENTION

Many display screens have been described and practiced in the prior art. Such screens are used on many modem conveniences and commonly on handheld devices including cell phones, personal computers, PDAs, pagers, cameras, video games, audio players, video players, and even print media tablets. One problem is common among nearly all handheld device display screens. Namely, to keep the devices portable, screen sizes have to be very small. No handheld devices (operating while being held by a user) that project an image onto a remote surface are known in the prior art. While U.S. Pat. No. 6,091,546 discloses using image stabilization to stabilize an image appearing in eyeglasses that are connected to a cell phone, no handheld devices that use image stabilization when projecting an image onto a remote screen are known in the prior art.

A technique for making relatively small displays produce large images is well know in image projectors. Current state of the art projectors can be quite small yet produce high quality images suitable for large audiences. Additionally, projection is commonly used to make large television viewing surfaces. The technology in projectors has advanced rapidly and significantly in recent years. Currently, high quality images are produced using either CRT and LCD transmissive elements or using reflective elements. In the LCD transmissive approach, light is passed through a LCD which has an image in it. The light picks up the image's colors when passing through the LCD and shines them (projects them) on a screen which is viewed by the audience. In a reflective approach, projection is achieved using colored lights and tiny mirrors. No example of a handheld projector is in the prior art. No examples of a handheld projector which utilizes image stabilization are know in the prior art.

Image stabilization has been brought to a mature technology in modem cameras. Techniques for stabilizing image recordings using digital, optical, and mechanical techniques have been described and practiced in prior art. Both U.S. Pat. No. 5,528,297 Seegert et al and U.S. Pat. No. 5,673,084 Lim et al teach the use of a projector function integrated into a camera. Images recorded by said camera being repayable by the integrated projector. Neither of these patents describe or anticipate image stabilization of the projected image. These integrated projectors are therefore not designed to operate in a handheld mode. No known prior art utilizes a means for image stabilization in a handheld device with an integrated means for projection.

The present invention includes a means to project an image from a handheld device wherein a means to stabilize the projected image is also provided.

### BRIEF SUMMARY

The invention described herein represents a significant improvement for the users of handheld devices. Heretofore a tradeoff has existed between device portability and screen size. The problem is that a small screen is not conducive to interacting with visual media and a large screen size is not conducive to carrying around. The present invention solves this compromise by keeping the device small yet enabling the user to produce a large screen display nearly anywhere, anytime, at their convenience.

The invention integrates within the handheld device a means to project an image onto a remote (not connected) surface. Further the means of projection is integrated with a means to stabilize the image. The result of this new art is that a user can be walking around in the city with their cell phone for example. The user points the image projector within their cell phone toward a remote surface (such as a wall) four feet in front of them, activates the projector, and dials up their wireless internet connection. As the user navigates on the internet using buttons on the cell phone, full size web pages are projected from the cell phone onto the remote surface. While the user inadvertently jiggles the cell phone slightly, the image on the remote surface is stationary. Motion and proximity sensors are integrated into the cell phone such that image stabilization techniques are used to stabilize the images position and size on the remote surface. Image stabilization enables the user to interact with the image projected by their handheld device comfortably and efficiently

Thus the present invention offers a significant advancement in visual communications through handheld devices.

### OBJECTS AND ADVANTAGES

Accordingly, several objects and advantages of my invention are apparent. It is an object of the present invention to provide a more portable handheld device. It is an object of the present invention to provide a dramatically larger visual image presentation from a handheld device. It is an object of the present invention to provide an image that is stable such that the user can interact with the visual information most efficiently. It is an object of the present invention to facilitate a user's ability to interact with high volumes of remote internet visual information wirelessly nearly any place at any time. It is an object of the present invention to provide a means for large interactive graphic presentations nearly anywhere at any time. It is an object of the present invention to provide a means to sense when the handheld device moves relative to the image. It is an object of the present invention to provide a means to sense the relative distance of the handheld device relative to a screen onto which it is projecting and image. It is an object of the present invention to use image stabilization techniques to enhance the user's experience with the visual information.

Further objects and advantages will become apparent from the enclosed figures and specifications.

### DRAWING FIGURES

FIG. 1 illustrates a means for projecting an image from a cell phone.

FIG. 2 illustrates the means of FIG. 1 except a means to stabilize the image has been activated.

FIG. 3 illustrates a fully assembled handheld cell phone projecting an email image onto a remote surface(wall).

FIG. 4 is a flowchart describing both definite and optional elements in the cell phone of FIG. 3.

FIG. 5 illustrates a fully assembled handheld video game projecting an email image onto a remote surface (wall).

FIG. 6 is a flowchart describing both definite and optional elements in the video game of FIG. 5.

FIG. 7 is a flowchart describing a process for projecting, sensing motion relative to, and stabilizing, an image which is projected onto a remote surface from a handheld device.

### DETAILED DESCRIPTION OF THE INVENTION

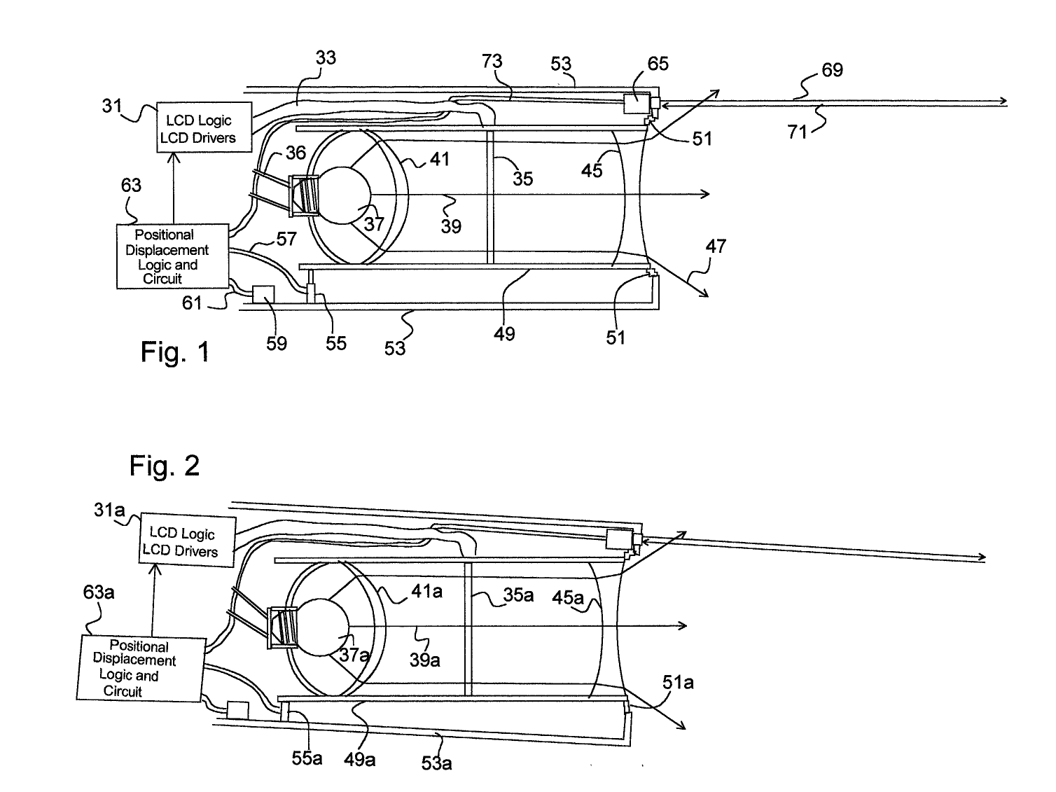

FIG. 1 illustrates a cutaway view of a means for projecting an image from a handheld device such as a cell phone. A LCD Logic and LCD Drivers 31 (receives from the cell phone circuitry and) conveys video image signals to a transparent LCD display 35 via a LCD ribbon cable 33. A light bulb 37 produces bright light 39 which passes through a collimating lens 41. Electricity for 37 being provided by illumination wire 36. When the 39 light passes through the LCD display 35, it becomes colored according to the pixels in 35. The light then passes through a divergent lens 45 which causes the collimated light to spread similar to divergent ray 47. The 37, 41, 35, and 45 elements are housed in a cylinder 49. Said cylinder and its contents constitute a means to project an image. 49 is sealably connected on a first end to a cell phone housing 53 by a flexible seal 51. 49 being connected on a second end to 53 by an actuation cylinder 55. 55 being an electromagnetic actuator powered by actuator wire 57 which carries a charge determined by positional displacement logic and circuit 63. 55 being a means to stabilize the image projected by a handheld device. 63 receives signals relating to the cell phone's position and movement from an optoelectronic inclination sensor 59 and an optical position displacement sensor 65. Signals to 63 coming from an inclination signal wire 61 and a displacement wire 73. The 63 calculates what actions are required to ensure that the image position produced by the light emanating from the elements within 49 remains steady. A steady image enables the user to view the image comfortably and efficiently. 65 senses the handheld unit's position from the image surface by sending an outgoing IR pulsed beam 69 and then recording the time elapsed before receiving reflected beam 71. Note that the elements of the cell phone not integral to the present invention have not been reproduced herein to avoid redundancy but the components shown do integrate with the cell phone's transmitter and receiver. Specifically, 31 receives information from the cell phone's receiver (which describes the visual image to be produced), the cell phone key pad (not shown) sends information to the cell phone's transmitter (for the internet dialog).

FIG. 2 illustrates the means of FIG. 1 except a means to stabilize the image has been activated. When the user tilts the cell phone down, 59 senses the change and sends a signal to 63a. 63a uses the information together with the distance information from 65 to calculate what action is required to keep the image in the same spot even as the cell phone is tilted. 63a sends a signal to produce a contracted electric actuation cylinder 55a being contracted to pull the stabilized cylinder 49a and its image producing elements into the required alignment to stabilize the image for the user. Additionally, 63a uses the sensed information from 65 and 59 to modify the way that the pixels are displayed on the modified LCD 35a via the digitally stabilized LCD Logic LCD Drivers 31a. 65 and 59 each being a means to sense motion of the handheld device. Thus the user sees an image which is not moved even though the cell phone itself has been moved. A digital means for stabilizing an image from a handheld device being illustrated in (31, 31a) and a mechanical/optical means for stabilizing an image from a handheld device being illustrated in (55, 55a). Note that the elements of the cell phone not integral to the present invention have not been reproduced herein to avoid redundancy.

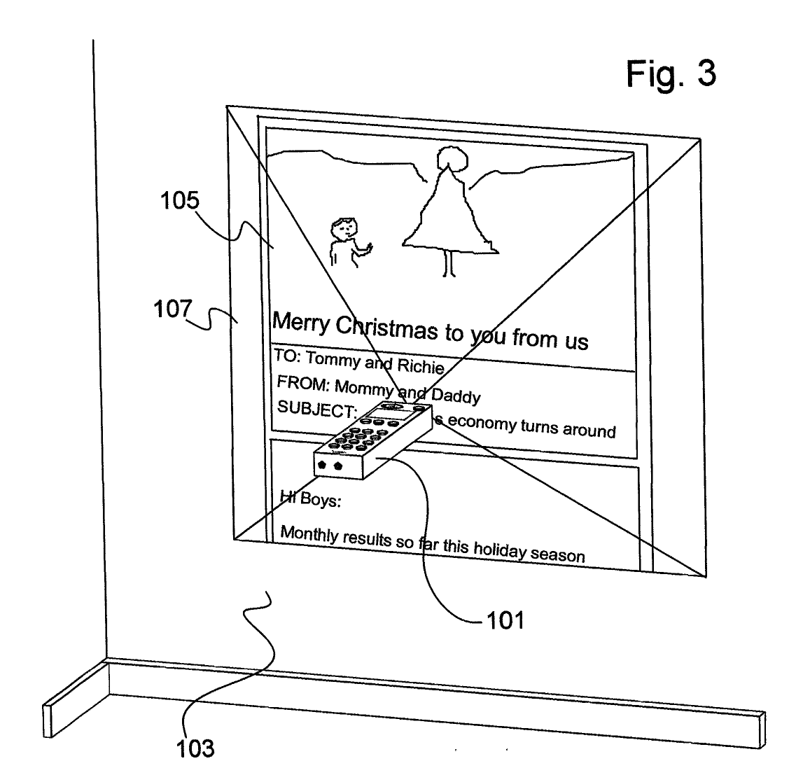

FIG. 3 illustrates a fully assembled handheld device such as a cell phone projecting an email image onto a remote surface (wall). A handheld cell phone 101 is shown fully assembled. It is equipped with the elements described in FIG. 1 and FIG. 2. In the illustration, it is producing an image of an email 105 that the user has received. Said image being displayed via projection onto a wall within a building 103. The background desktop 107 is also being projected by the 101. As the user views this email or navigates elsewhere, the cell phone, using a means to project, a means to sense, and a means to stabilize, projects the image onto the wall, senses cell phone movement, and keeps the image stable.

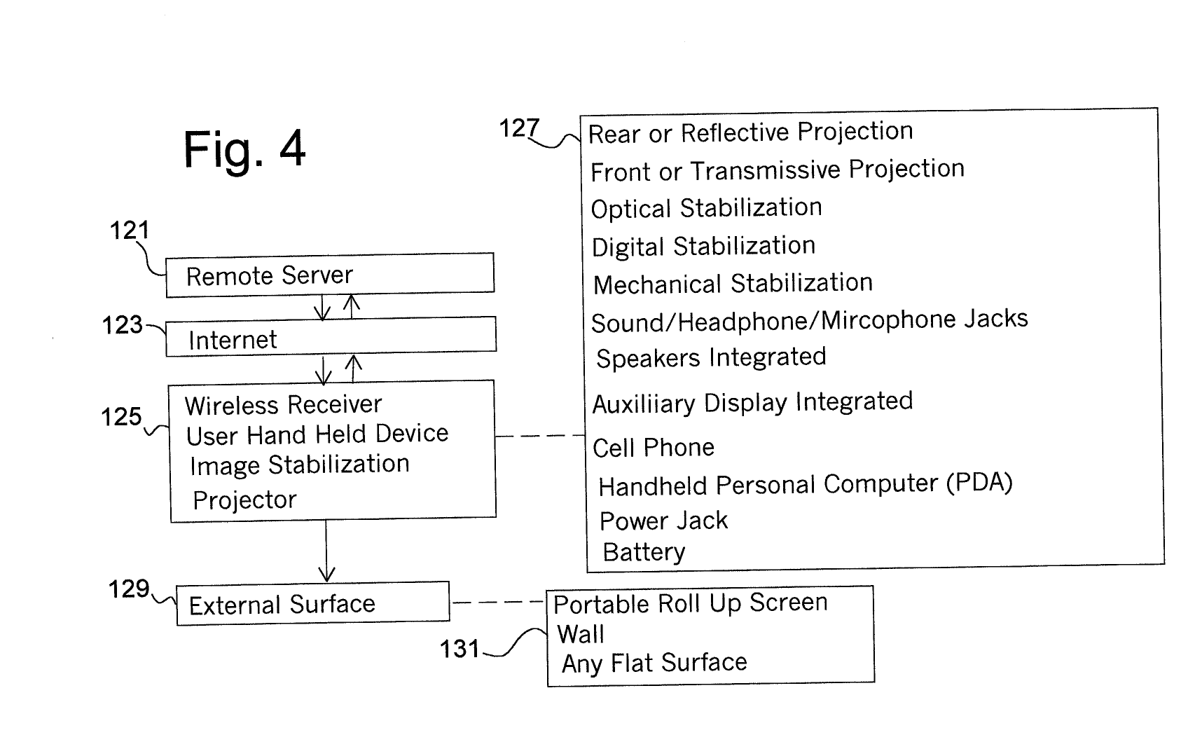

FIG. 4 is a flowchart describing both definite elements and possible elements in the 125 handheld device of FIG. 3. A remote server 121 contains content which the user is interested in viewing. The user accesses the 121 through the internet 123 using a wireless receiver (or cell phone) 125. The user pushes buttons on the 125 to interact with the 121 such that the email displayed in FIG. 3 is projected from the handheld device onto an external surface 129. Contained within the 125 are a wireless receiver, image stabilization means (including sensors and logic and circuits), and projection means. Possible options 127 are representative of options that may or may not be contained within the 125. 127 options include; rear or reflective projection, front or transmissive projection, optical stabilization, digital stabilization, mechanical stabillzation, sound/headphone/microphone jacks, integrated speakers, auxiliary display integrated, cell phone, handheld personal computer, PDA, power jack, and battery. Likewise, 129 could consist of any of the screen options 131. 131 could be a wall as in illustration FIG. 3 or it can be a portable roll up screen, or any substantially flat surface.

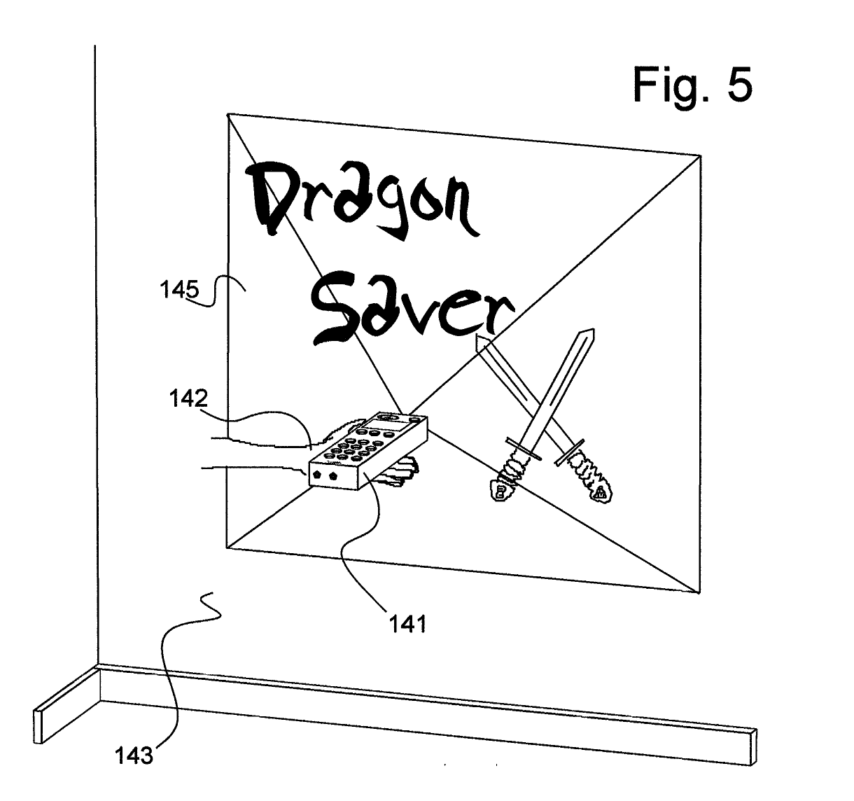

FIG. 5 illustrates a fully assembled handheld device such as a video game projecting a game title screen onto a remote surface (wall) 143. A hand 142 holds the handheld device 141. The 141 contains the elements of FIGS. 1 and 2. It produces a projected image of a game 145 onto a second remote surface (or wall) 143. The user is able to interact with the game while enjoying a projected, stabilized, large, video image.

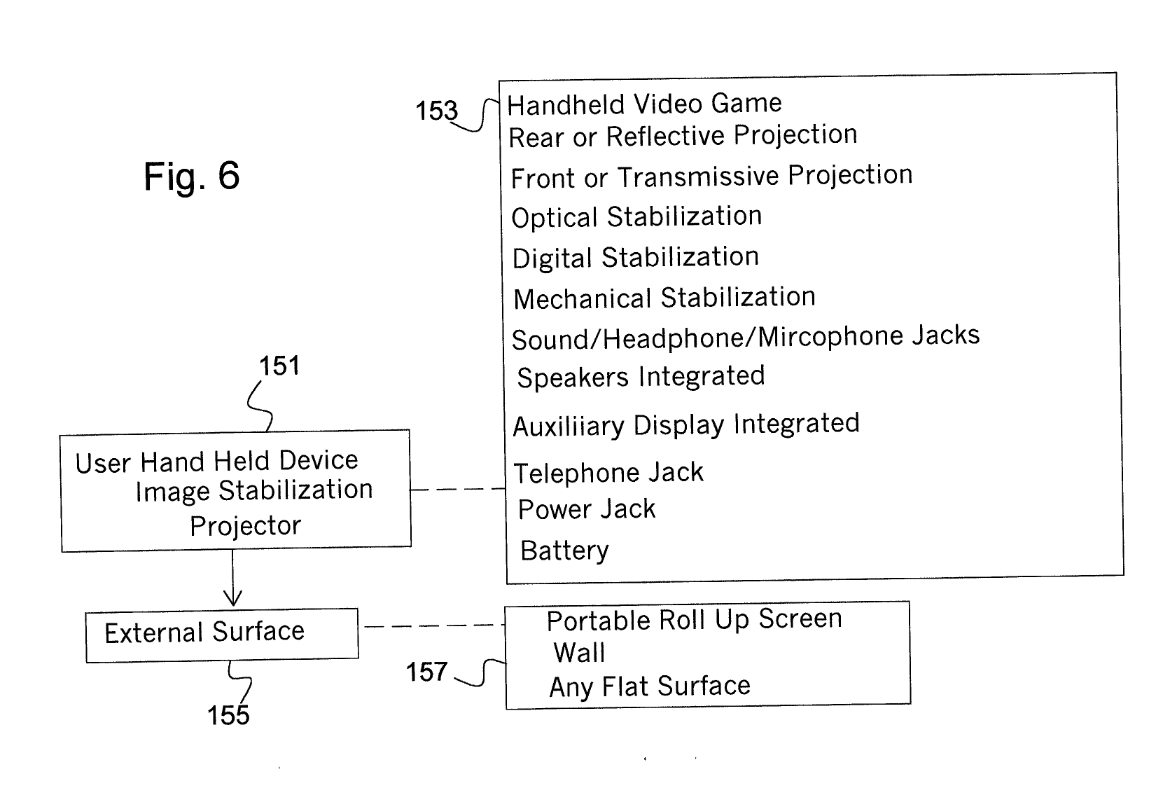

FIG. 6 is a flowchart describing definite and possible elements in the video game of FIG. 5. The video handheld device 151 contains the means of image stabilization and projection. It projects an image on an external surface 155. The 151 device may contain any or all of the elements in 153. They include; rear or reflective projection, front or transmissive projection, optical stabilization, digital stabilization, mechanical stabilization, sound/headphone/microphone jacks, integrated speakers, auxiliary display integrated, cell phone, telephone jack, handheld personal computer (PDA), power jack, and battery

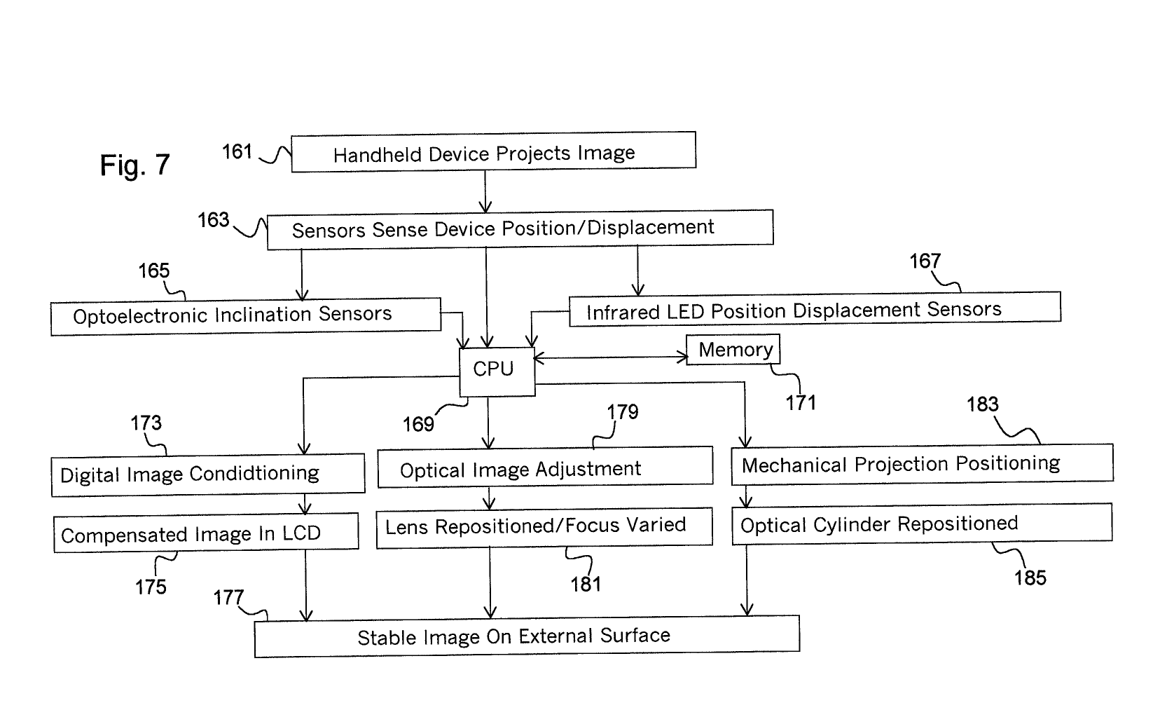

FIG. 7 is a flowchart describing a process for projecting, sensing motion relative to, and stabilizing, an image which is projected onto a remote surface from a handheld device. A handheld device projects an image 161. Sensors sense the device's position changes and displacement 163. 163 reports to a CPU 169. Examples of sensors include a optoelectronic Inclination sensor 165 and an infrared LED position displacement sensor 167. 165 and 167 report to the 169. 169 pulls values from memory 171 and also stores information in 171. The CPU calculates what actions must be taken to offset the movements and positions that have been sensed and pulled from memory. It then sends signals to digital image conditioning means 173, optical image adjustment means 179, and/or the mechanical projection positioning means. Each of these in turn perform functions as specified respectively, compensate image on LCD 175, lens repositioned/focus varied 181, optical cylinder repositioned 185. The end result of these actions is a stable image on external surface 177.

### Operation of the Invention

FIG. 1 illustrates a cutaway view of a means for projecting an image from a handheld device such as a cell phone. A LCD Logic and LCD Drivers 31 (receives from the cell phone circuitry and) conveys video image signals to a transparent LCD display 35 via a LCD ribbon cable 33. A light bulb 37 produces bright light 39 which passes through a collimating lens 41. Electricity for 37 being provided by illumination wire 36. When the 39 light passes through the LCD display 35, it becomes colored according to the pixels in 35. The light then passes through a divergent lens 45 which causes the collimated light to spread similar to divergent ray 47. The 37, 41, 35, and 45 elements are housed in a cylinder 49. Said cylinder and its contents constitute a means to project an image. 49 is sealably connected on a first end to a cell phone housing 53 by a flexible seal 51. 49 being connected on a second end to 53 by an actuation cylinder 55. 55 being an electromagnetic actuator powered by actuator wire 57 which carries a charge determined by positional displacement logic and circuit 63. 55 being a means to stabilize the image projected by a handheld device. 63 receives signals relating to the cell phone's position and movement from an optoelectronic inclination sensor 59 and an optical position displacement sensor 65. Signals to 63 coming from an inclination signal wire 61 and a displacement wire 73. The 63 calculates what actions are required to ensure that the image position produced by the light emanating from the elements within 49 remains steady. A steady image enables the user to view the image comfortably and efficiently. 65 senses the handheld unit's position from the image surface by sending an outgoing IR pulsed beam 69 and then recording the time elapsed before receiving reflected beam 71. Note that the elements of the cell phone not integral to the present invention have not been reproduced herein to avoid redundancy but the components shown do integrate with the cell phone's transmitter and receiver. Specifically, 31 receives information from the cell phone's receiver (which describes the visual image to be produced), the cell phone key pad (not shown) sends information to the cell phone's transmitter (for the internet dialog).

FIG. 2 illustrates the means of FIG. 1 except a means to stabilize the image has been activated. When the user tilts the cell phone down, 59 senses the change and sends a signal to 63a. 63a uses the information together with the distance information from 65 to calculate what action is required to keep the image in the same spot even as the cell phone is tilted. 63a sends a signal to produce a contracted electric actuation cylinder 55a being contracted to pull the stabilized cylinder 49a and its image producing elements into the required alignment to stabilize the image for the user. Additionally, 63a uses the sensed information from 65 and 59 to modify the way that the pixels are displayed on the modified LCD 35a via the digitally stabilized LCD Logic LCD Drivers 31a. 65 and 59 each being a means to sense motion of the handheld device. Thus the user sees an image which is not moved even though the cell phone itself has been moved. A digital means for stabilizing an image from a handheld device being illustrated in (31, 31a) and a mechanical/optical means for stabilizing an image from a handheld device being illustrated in (55, 55a). Note that the elements of the cell phone not integral to the present invention have not been reproduced herein to avoid redundancy.

FIG. 3 illustrates a fully assembled handheld device such as a cell phone projecting an email image onto a remote surface (wall). A handheld cell phone 101 is shown fully assembled. It is equipped with the elements described in FIG. 1 and FIG. 2. In the illustration, it is producing an image of an email 105 that the user has received. Said image being displayed via projection onto a wall within a building 103. The background desktop 107 is also being projected by the 101. As the user views this email or navigates elsewhere, the cell phone, using a means to project, a means to sense, and a means to stabilize, projects the image onto the wall, senses cell phone movement, and keeps the image stable.

FIG. 4 is a flowchart describing both definite elements and possible elements in the 125 handheld device of FIG. 3. A remote server 121 contains content which the user is interested in viewing. The user accesses the 121 through the internet 123 using a wireless receiver (or cell phone) 125. The user pushes buttons on the 125 to interact with the 121 such that the email displayed in FIG. 3 is projected from the handheld device onto an external surface 129. Contained within the 125 are a wireless receiver, image stabilization means (including sensors and logic and circuits), and projection means. Possible options 127 are representative of options that may or may not be contained within the 125. 127 options include; rear or reflective projection, front or transmissive projection, optical stabilization, digital stabilization, mechanical stabilization, sound/headphone/microphone jacks, integrated speakers, auxiliary display integrated, cell phone, handheld personal computer, PDA, power jack, and battery. Likewise, 129 could consist of any of the screen options 131. 131 could be a wall as in illustration FIG. 3 or it can be a portable roll up screen, or any substantially flat surface.

FIG. 5 illustrates a fully assembled handheld device such as a video game projecting a game title screen onto a remote surface (wall) 143. A hand 142 holds the handheld device 141. The 141 contains the elements of FIGS. 1 and 2. It produces a projected image of a game 145 onto a second remote surface (or wall) 143. The user is able to interact with the game while enjoying a projected, stabilized, large, video image.

FIG. 6 is a flowchart describing definite and possible elements in the video game of FIG. 5. The video handheld device 151 contains the means of image stabilization and projection. It projects an image on an external surface 155. The 151 device may contain any or all of the elements in 153. They include; rear or reflective projection, front or transmissive projection, optical stabilization, digital stabilization, mechanical stabilization, sound/headphone/microphone jacks, integrated speakers, auxiliary display integrated, cell phone, telephone jack, handheld personal computer (PDA), power jack, and battery

FIG. 7 is a flowchart describing a process for projecting, sensing motion relative to, and stabilizing, an image which is projected onto a remote surface from a handheld device. A handheld device projects an image 161. Sensors sense the device's position changes and displacement 163. 163 reports to a CPU 169. Examples of sensors include a optoelectronic Inclination sensor 165 and an infrared LED position displacement sensor 167. 165 and 167 report to the 169. 169 pulls values from memory 171 and also stores information in 171. The CPU calculates what actions must be taken to offset the movements and positions that have been sensed and pulled from memory. It then sends signals to digital image conditioning means 173, optical image adjustment means 179, and/or the mechanical projection positioning means. Each of these in turn perform functions as specified respectively, compensate image on LCD 175, lens repositioned/focus varied181, optical cylinder repositioned 185. The end result of these actions is a stable image on external surface 177.

### Conclusion, Ramifications, and Scope

Thus the reader will see that the Handheld Device With Integrated Projector of this invention provides a novel unanticipated, highly functional and reliable means for using optical and electronic technologies to vastly improve the visual display performance of many handheld devices.

While my above description describes many specifications, these should not be construed as limitations on the scope of the invention, but rather as an exemplification of a preferred embodiment thereof. Many other variations are possible. For example, many techniques for projecting images are well known and could be used by one skilled in the art. Many optical elements and combinations thereof are possible. Many position sensing and displacement sensing techniques are known that could be used herein. Many image stabilizing techniques are known including digital, optical, and mechanical that could be used herein. Many functions can be performed by handheld devices which have not been enumerated herein, it will be understood that the present invention can be used with any handheld device which can benefit from improved presentation of visual media. The functioning elements of the specific handheld devices have not been reproduced herein but the devices shown are assumed to include elements common to these devices.

I claim:

1. A handheld means for displaying an image,
wherein a means for projecting an image onto a remote surface is provided,
wherein a means for detecting movement of said handheld device is provided,
wherein a means for offsetting said movement and thereby stabilizing said image is provided.

2. The invention of claim 1 wherein said handheld means includes the means to connect to a remote computer.

3. The invention of claim 1 wherein said handheld means is designed to produce an image in response to software instructions.

4. A process for producing an image from a handheld device,
wherein said image is projected from said handheld device onto a remote surface,
wherein movement of said handheld device relative to said remote surface is sensed,
wherein adjustments within said handheld device are made to offset said movement.

5. The invention of claim 4 wherein said handheld device includes the means to connect to a remote computer.

6. The invention of claim 4 wherein said handheld device is designed to produce an image in response to software instructions.
